(19) United States
(12) Patent Application Publication
(10) Pub. No.: US 2013/0211887 A1
(43) Pub. Date: Aug. 15, 2013

(54) MULTIMEDIA ADVERTISEMENT DISPLAY METHOD AND SYSTEM USING TOUCH SCREEN AND PROJECTOR

(71) Applicants: Jun H. Kim, Seoul (KR); Eun H. Lee, Seoul (KR); Jeong B. Kim, Seoul (KR); Do Y. Sung, Seoul (KR); Jong U. Won, Ulsan (KR); Jong M. Choi, Seoul (KR); Oh H. Kwon, Seoul (KR); Keun G. Seok, Gyeonggi-do (KR); Jin W. Park, Seoul (KR)

(72) Inventors: Jun H. Kim, Seoul (KR); Eun H. Lee, Seoul (KR); Jeong B. Kim, Seoul (KR); Do Y. Sung, Seoul (KR); Jong U. Won, Ulsan (KR); Jong M. Choi, Seoul (KR); Oh H. Kwon, Seoul (KR); Keun G. Seok, Gyeonggi-do (KR); Jin W. Park, Seoul (KR)

(73) Assignee: D'STRICT HOLDINGS CO., LTD., Seoul (KR)

(21) Appl. No.: 13/809,108

(22) PCT Filed: Apr. 21, 2011
(86) PCT No.: PCT/KR2011/002890

§ 371 Date: Mar. 20, 2013

(30) Foreign Application Priority Data
Jul. 9, 2010 (KR) 10-2010-0066386
Jan. 27, 2011 (KR) 10-2011-0008384

(51) Int. Cl. G06Q 30/02

(52) U.S. Cl. CPC G06Q 30/0241
USPC 705/14.4

(57) ABSTRACT

A method and system for displaying a multimedia advertisement using a touch screen and a projector, the method and system displaying a plurality of icons such as an advertising icon, and the like, on a touch screen, and displaying a multimedia advertisement corresponding to an icon on a wall screen using a projector when the icon deviates from an area of the touch screen in response to a touch event of a user, is provided.

### TECHNICAL FIELD

The present invention relates to a method and system for displaying a multimedia advertisement using a touch screen and a projector.

### BACKGROUND ART

A touch screen is an input device and a display device performing an input and a display of information on a single screen. The touch screen may increase a display area and enable a user to operate intuitively because an additional input device is not required. However, when a video is displayed on a wide area using the touch screen, an increase of a screen size may entail a higher cost and a greater calorific value.

When a one way transfer of an advertisement is conducted without user participation, efficient advertising may be difficult due to a low level of interest in the advertisement.

### DISCLOSURE OF INVENTION

### Technical Goals

An aspect of the present invention provides a method and system for playing a multimedia advertisement corresponding to an icon when an advertising icon displayed on a touch screen is moved to a wall screen differing from the touch screen or a display device, in response to a touch event.

### Technical Solutions

According to an aspect of the present invention, there is provided a method for displaying a multimedia advertisement using a touch screen and a projector, the method including displaying at least one icon including an advertising icon on a touch screen, receiving an input of a touch event with respect to a first icon selected by a user from among the at least one icon, determining whether the first icon selected by the user deviates from a boundary of the touch screen by the touch event, and displaying multimedia content corresponding to the first icon selected by the user on a wall screen using at least one projector based on the determination.

The touch screen and the wall screen may be disposed in an arrangement in which the boundary of the touch screen and a boundary of the wall screen are connected.

The displaying of the multimedia content corresponding to the first icon selected by the user on the wall screen may include displaying an image on the wall screen in an arrangement in which an image displayed on the boundary of the touch screen and an image displayed on the boundary of the wall screen are connected.

The displaying of the multimedia content corresponding to the first icon selected by the user on the wall screen may include displaying the multimedia content corresponding to the first icon selected by the user on the wall screen when the first icon selected by the user arrives at a predetermined area of the wall screen in response to the touch event.

The displaying of the multimedia content corresponding to the first icon selected by the user on the wall screen may include displaying the first icon selected by the user in a floating disposition on the wall screen, and deleting the first icon selected by the user from the wall screen subsequent to a predetermined duration of time elapsing.

The displaying of the multimedia content corresponding to the first icon selected by the user on the wall screen may include printing advertising content or a coupon corresponding to the advertising icon, or transmitting the advertising content or the coupon to a mobile phone of a user when the first icon selected by the user is the advertising icon.

The displaying of the at least one icon may include displaying a photographing icon, and further include photographing being performed in response to an input of a touch event with respect to the photographing icon being received, and displaying a picture icon displaying the photographed picture on the touch screen.

The displaying of the multimedia content corresponding to the first icon selected by the user on the wall screen may include printing the photographed picture, or transmitting the photographed picture to a mobile phone of a user when the first icon selected by the user is the picture icon.

The method for displaying the multimedia advertisement using the touch screen and the projector may further include displaying at least one multimedia advertisement on the wall screen using the at least one projector, irrespective of the touch event.

According to another aspect of the present invention, there is provided a system for displaying a multimedia advertisement using a touch screen and a projector, the system including a touch screen to display at least one icon including an advertising icon, and receive an input of a touch event with respect to a first icon selected by a user from among the at least one icon, at least one projector to display multimedia content corresponding to the first icon selected by the user on a wall screen when the first icon selected by the user deviates from a boundary of the touch screen, and a control module to control an operation of the touch screen and the at least one projector.

The touch screen may be disposed in an arrangement in which the boundary of the touch screen and a boundary of the wall screen are connected.

The at least one projector may display an image on the wall screen in an arrangement in which an image displayed on the boundary of the touch screen and an image displayed on the wall screen are connected.

The control module may determine whether the first icon selected by the user arrives at a predetermined area of the wall screen in response to the touch event, and when the first icon selected by the user is determined to arrive at the predetermined area of the wall screen, may control the at least one projector to display the multimedia content corresponding to the first icon selected by the user on the wall screen.

The control module may display the first icon selected by the user in a floating disposition on the wall screen when the first icon deviates from the boundary of the touch screen, and subsequent to a predetermined duration of time elapsing, may control the at least one projector to delete the first icon selected by the user from the wall screen.

The system for displaying the multimedia advertisement using the touch screen and the projector may further include a printer to print a picture corresponding to advertising content or coupon corresponding to the advertising icon or a picture icon when the first icon selected by the user is the advertising icon or the picture icon, or the control module may transmit the image corresponding to the advertising content or coupon corresponding to the advertising icon or a picture icon to a mobile phone of a user when the first icon selected by the user is the advertising icon or the picture icon.

According to still another aspect of the present invention, there is provided a system for displaying a multimedia advertisement using a touch screen, the system including a touch screen to display at least one icon including an advertising icon, and receive an input of a touch event with respect to a first icon selected by a user from among the at least one icon, a display device distinguished from the touch screen to display multimedia content corresponding to the first icon selected by the user, in response to the touch event, and a control module to control an operation of the touch screen and the display device, wherein the control module determines whether the multimedia content corresponding to the first icon selected by the user is to be displayed on the display device in response to the touch event.

The control module may determine whether the multimedia content corresponding to the first icon selected by the user is to be displayed on the display device based on whether the first icon selected by the user deviates from a boundary of the touch screen by the touch event.

The at least one icon may include at least one of a fun icon, a photographing icon, a picture icon, and a video icon.

The control module may receive a picture or a video via an Internet network or via a mobile communication network from a mobile device, and the touch screen may display a picture icon or a video icon corresponding to the picture or the video.

The system for displaying the multimedia advertisement using the touch screen may further include a camera for photographing to be performed in response to a touch event with respect to a photographing icon displayed on the touch screen, wherein the touch screen displays a picture icon based on the photographed picture.

The control module may create the picture icon based on the advertising icon and the photographed picture.

The system for displaying the multimedia advertisement using the touch screen may further include a printer to print a picture corresponding to advertising content or coupon corresponding to the advertising icon or the picture icon, based on the touch event according to a control by the control module.

### Advantageous Effects

According to an embodiment of the present invention, it is possible to reduce a cost and a calorific value, despite having a wide display area, by displaying multimedia content using a touch screen along with a projector. Also, a visual effect of viewing the multimedia advertising content may be enhanced by displaying the multimedia advertising content corresponding to an advertising icon displayed on the touch screen, on a large wall screen using the projector.

According to an embodiment of the present invention, a user is enabled to view an advertisement in a more enjoyable manner by playing advertising content corresponding to an advertising icon selected by the user in response to various touch events, for example, flicking, clicking, and the like. Transitively, an effect of the advertisement is increased. Accordingly, a level of interest of the user as to an advertisement may increase since the advertisement is transferred by a selection from and participation of the user rather than a one way transfer via a display system.

According to an embodiment of the present invention, it is possible to enhance user satisfaction by providing varied multimedia content available for the user, rather than transferring only an advertisement to the user via a screen.

According to an embodiment of the present invention, it is possible to maintain an advertisement in a memory of a user for a long period of time, aside from an instant effect of the advertisement by playing a multimedia advertisement based on a selection of the user, and printing a coupon or advertising content corresponding to the advertisement or transmitting the coupon or advertising content to a mobile phone, thus leading to an enhanced advertisement effect.

According to an embodiment of the present invention, it is possible to enhance user satisfaction by photographing a picture of a user through operating a touch screen, and printing a picture through a touch event or transmitting the picture to a mobile phone.

According to an embodiment of the present invention, it is possible to entice a user into playing film advertising videos by playing a corresponding different film advertising video in response to a touch event with respect to different film icons displayed on a touch screen.

According to an embodiment of the present invention, there is provided a system for displaying an advertisement that receives a picture or a video via an Internet network or a mobile communication network, and displays a plurality of icons corresponding to the picture or the video on a touch screen in order to print a picture photographed or a video recorded in advance by the user.

### BRIEF DESCRIPTION OF DRAWINGS

FIG. 1 is a diagram illustrating a system for displaying a multimedia advertisement using a touch screen and a projector according to an embodiment of the present invention.

FIG. 2 is a diagram illustrating an example in which multimedia content is displayed on a wall screen in response to a touch event of a user with respect to a touch screen or a second touch screen according to an embodiment of the present invention.

FIG. 3 is a diagram illustrating a process of printing and transmitting to a mobile phone in response to a touch event with respect to a photographing icon according to an embodiment of the present invention.

FIG. 4 is a diagram illustrating an example in which a film advertisement is displayed using a system for displaying a multimedia advertisement using a touch screen and a projector according to an embodiment of the present invention.

FIG. 5 is a flowchart illustrating a method for displaying a multimedia advertisement using a touch screen and a projector according to an embodiment of the present invention.

FIG. 6 is a flowchart illustrating a method for displaying a multimedia advertisement using a touch screen and a projector according to another embodiment of the present invention.

FIG. 7 is a diagram illustrating a system for displaying a multimedia advertisement using a touch screen according to an embodiment of the present invention.

FIG. 8 is a diagram illustrating a system for displaying a multimedia advertisement using a touch screen according to another embodiment of the present invention.

FIG. 9 is a diagram illustrating a system for displaying a multimedia advertisement using a touch screen that receives a picture or a video via an Internet network or a mobile communication network according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

When it is determined that a detailed description related to a related known function or configuration which may make the purpose of the present invention unnecessarily ambiguous in the description of the present invention, such detailed description will be omitted. Also, terminologies used herein are defined to appropriately describe the exemplary embodiments of the present invention and thus may be changed depending on a user, the intent of an operator, or a custom. Accordingly, the terminologies must be defined based on the following overall description of this specification.

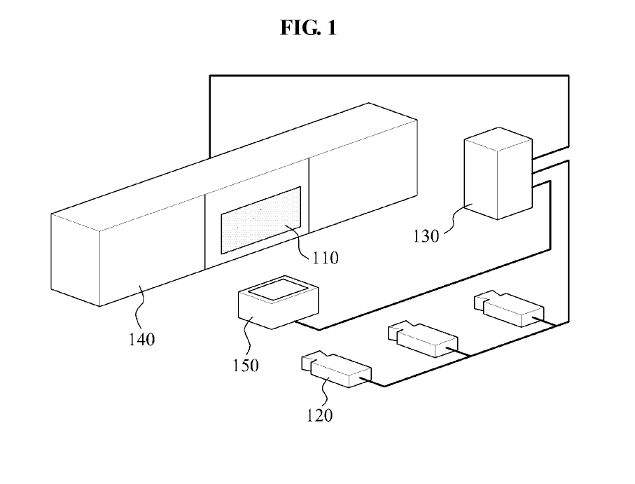

FIG. 1 is a diagram illustrating a system for displaying a multimedia advertisement using a touch screen and a projector according to an embodiment of the present invention.

Referring to FIG. 1, the system for displaying the multimedia advertisement using the touch screen and the projector includes a touch screen 110, a projector 120, a control module 130, and a wall screen 140. The system may further include a second touch screen 150.

The touch screen 110 may display at least one icon including an advertising icon. The touch screen 110 may receive an input of a touch event with respect to a first icon selected by a user from among the at least one icon. As an example, the touch screen 110 may be a multi touch screen.

The touch event may include clicking, dragging, flicking, and the like. The clicking may refer to an operation of a user tapping on a portion of the touch screen 110 lightly and releasing the portion being tapped on. The dragging may refer to an operation of a finger of a user, and the like, moving along a surface of the touch screen 110 while being pressed down on a portion of the touch screen 110. The flicking may refer to an operation of a finger of a user tapping on a portion of the touch screen 110 lightly, and releasing the touch screen 110 in a manner similar to brushing being performed in a predetermined direction.

The projector 120 may display multimedia content corresponding to a first icon on the wall screen 140 when the first icon deviates from a boundary of the touch screen 110. In this instance, the projector 120 may be plural. The projector 120 may be disposed on a ceiling of a space in which a system for displaying an advertisement is installed. Accordingly, although an object or a person may exist between the projector 120 and the wall screen 140, interference with a video being displayed on the wall screen 140 may be absent.

The control module 130 may control an operation of the touch screen 110, the second touch screen 150, and the projector 120. The control module 130 may be disposed on a back of the touch screen 110 or the wall screen 140. The control module 130 may control the touch screen 110 and the projector 130 in an arrangement in which a video displayed on the touch screen 110 and a video displayed on the wall screen 140 are connected. The control module 130 may be a conventional computer system.

The wall screen 140 may be a screen on which a video from the projector 120 may be displayed. The wall screen 140 may be disposed in an arrangement in which the wall screen 140 surrounds the touch screen 110. In particular, the touch screen 110 and the wall screen 140 may be disposed in an arrangement in which the boundary of the touch screen 110 and a boundary of the wall screen 140 are connected. Accordingly, a video displayed on the touch screen 110 and a video displayed on the wall screen 140 may be connected. As an example, the wall screen 140 may be a screen used in a movie theater.

A touch event may be input through the second touch screen 150, rather than the touch screen 110 installed along with the wall screen 140. The second touch screen 150 may be disposed on a location separate from the wall screen 140. The second touch screen 150 may perform the same function as the touch screen 110. The second touch screen 150 and the touch screen 110 may be installed simultaneously.

Hereinafter, an operation of the touch screen 110, the second touch screen 150, the projector 120, and the control module 130 in response to a touch event of a user will be described in detail.

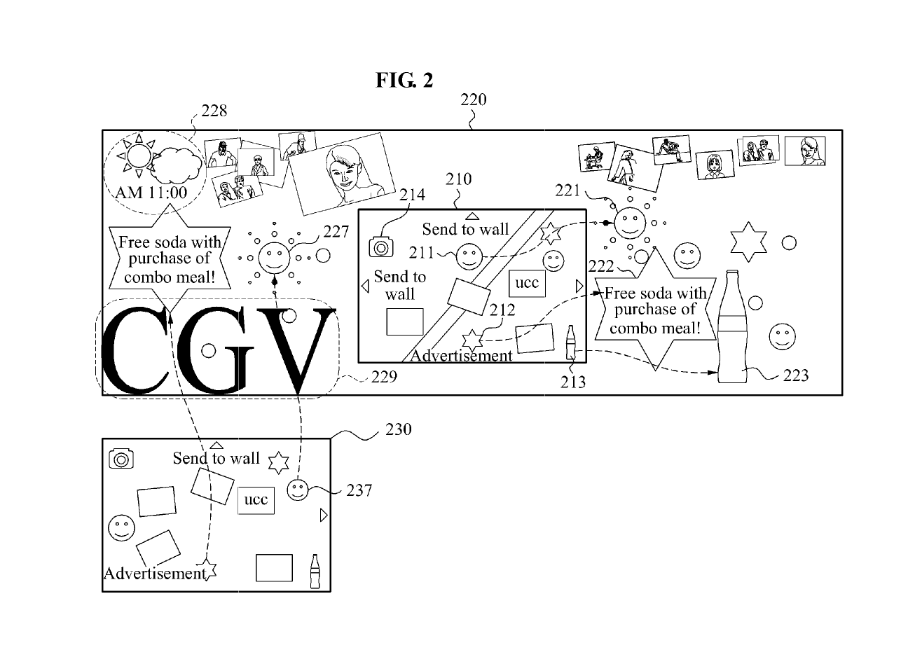

FIG. 2 is a diagram illustrating an example in which multimedia content is displayed on a wall screen in response to a touch event of a user with respect to a touch screen 210 or a second touch screen according to an embodiment of the present invention.

Referring to FIG. 2, the touch screen 210 displays at least one icon including an advertising icon 212. A fun icon 211, a photographing icon 214, an advertisement logo icon 213, a film icon (not shown), and the like, may be displayed on the touch screen 210. The aforementioned plurality of icons may be displayed in a floating disposition on the touch screen 210.

A user may input a touch event with respect to one of the plurality of icons displayed on the touch screen 210. For example, the user may perform flicking on a corresponding icon for a predetermined icon to deviate from a boundary of the touch screen 210.

A control module may determine whether an icon selected by the user deviates from an area of the touch screen 210 through a touch event, and arrives at an area of a wall screen 220.

When the selected icon arrives at the area of the wall screen 220, the control module may control a projector for multimedia content corresponding to the selected icon to be displayed on the wall screen 220. The control module may control the projector for the multimedia content corresponding to the selected icon to be displayed on the wall screen 220 when the selected icon arrives at a predetermined area within the wall screen 220. The multimedia content may be displayed on a portion at which the selected icon arrives.

For example, when the selected icon is the fun icon 211, the projector may display multimedia content 221 corresponding to a shape of the fun icon 211 on the wall screen 220. For example, in a case of a moon-shaped icon, a moon shape may be displayed in a background of the wall screen 220, or a motion clip associated with the moon may be played. In a case of a fire-shaped icon, a motion clip of fireworks may be played on the wall screen 220. Other various icons and a plurality of motion clips corresponding to the other various icons may be played.

When the selected icon is the advertising icon 212, the projector may display content 222 of a corresponding advertisement on the wall screen 220, or play a video related to the corresponding advertisement. Alternatively, content of an event related to an advertisement may be displayed on the wall screen 220. The user may participate in a corresponding event when the user views the content of the event. Also, a coupon related to an advertisement may be displayed on the wall screen 220. The user may use a corresponding coupon in an off-line store by photographing the coupon displayed on the wall screen 220. As an example, the advertising icon 212 may be related to a film. The user may output the corresponding coupon based on a direction of flicking with respect to the advertising icon 212 or an arrival position of the corresponding advertising icon 212, or receive the corresponding coupon via a mobile phone. Hereinafter, further descriptions pertaining to content of an event related to an advertisement will be provided.

In a case of the advertisement logo icon 213, an enlarged advertisement logo icon 223 may be displayed on a portion at which the advertisement logo icon 213 arrives. A memory of an advertisement may last for a long period of time since an advertisement logo may be played as a result of a voluntary participation of a user.

The photographing icon 214 may perform photographing, and descriptions related to photographing being performed will be provided hereinafter.

When the icon selected by a touch event deviates from the touch screen 210, the projector may display a corresponding icon or corresponding multimedia content in a floating disposition on the wall screen 230. The control module may control the projector to delete the corresponding icon or the corresponding multimedia content from the wall screen 220 subsequent to a predetermined duration of time elapsing. The control module may re-display the icon deleted from the wall screen 220 on the touch screen 210.

The operation described above may also be performed through a second touch screen 230. Here, various icons may be displayed on the second touch screen 230. For example, when a user moves a fun icon 237 toward the wall screen 220 by flicking, multimedia content 227 corresponding to the fun icon 237 may be displayed on the wall screen 220 as in a case of the touch screen 210. The principle detailed in the preceding may be applied to other icons.

Weather and clock information 228 may be displayed on the wall screen 220. When the system for displaying the multimedia advertisement is installed in a movie theater, a logo 229 of the movie theater may be displayed on the wall screen 220.

The control module may control the projector to display a multimedia advertisement on the wall screen 220, irrespective of an input of a touch event of the user through the touch screen 220 or the second touch screen 230.

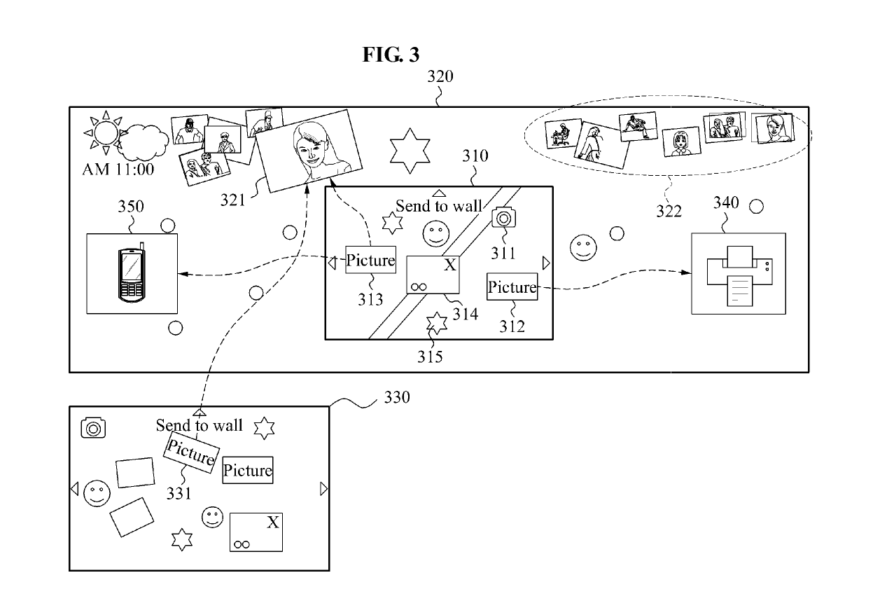

FIG. 3 is a diagram illustrating a process of printing and transmitting to a mobile phone in response to a touch event with respect to a photographing icon 311 according to an embodiment of the present invention.

Referring to FIG. 3, a touch screen 310 displays the photographing icon 311. A user may perform photographing by selecting the photographing icon 311. A camera may be installed to be connected to the touch screen 310.

The user may edit a photographed picture using a picture editing menu 314.

A control module may control the touch screen 310 to create the photographed picture as picture icons 313 and 312, and to display the created picture icons 313 and 312 on the touch screen 310.

The user may move the picture icon 313 in an upward direction of the touch screen 310 by flicking. When the picture icon 313 passes through an upper boundary of the touch screen 310, an enlarged picture 321 may be displayed on the wall screen 320. Picture icons moved in the upward direction of the touch screen 310 may float like clouds in a user created contents (UCC) area 322 on a top of the wall screen 320. Picture icons may overlap based on an arrival position or arrival order of the picture icons. The picture icons displayed on the UCC area 322 may be deleted subsequent to a predetermined duration of time elapsing.

The user may move the picture icon 312 toward a printer menu 340 by flicking. In response to the picture icon 312 passing through a right side boundary of the touch screen 310, a picture corresponding to the picture icon 312 may be printed by a printer. In this instance, the printer may be installed behind the wall screen 320 on which the printer menu 340 is displayed. A picture output as a result of the process described in the preceding may be released through a portion on which the printer menu 340 is displayed. Further, a location of the printer is not limited to being installed behind the wall screen 320 and may be installed at a location as needed.

The user may move the image icon 313 in a direction toward a mobile phone transmission menu 350 by flicking. In response to the picture icon 313 passing through a left side boundary of the touch screen 310, a picture corresponding to the picture icon 313 may be transmitted by the control module to a mobile phone of the user. Also, in lieu of being transmitted to a mobile phone, a photographed picture may be transmitted to an e-mail address of the user.

The control module may control the printer to print a corresponding picture when the picture icons 312 and 313, moved as a result of being flicked by the user, arrive at an area on which the printer menu 340 or the mobile phone transmission menu 350 is displayed, or transmit the corresponding picture to the mobile phone of the user. When the picture icons 312 and 313 pass through the boundary of the touch screen 310 yet fail to arrive at the area on which the printer menu 340 or the mobile phone transmission menu 350 is displayed, the control module may control the projector to move the picture icons 312 and 313 to the UCC area 322.

Operations associated with the printer menu 340 and the mobile phone transmission menu 350 may be applied to an advertising icon 315 including a coupon, an event, a film, and the like, as well as photographing.

The user may photograph a picture through the same principle as that of a touch screen 310, and transmit the photographed picture to the mobile phone or print the photographed picture. When the user moves a picture icon 331 of the second touch screen 330 toward the wall screen 320, an enlarged picture 321 may be displayed on the wall screen 320 as in the case of the touch screen 310. Also, picture icons may be displayed on the UCC area 322.

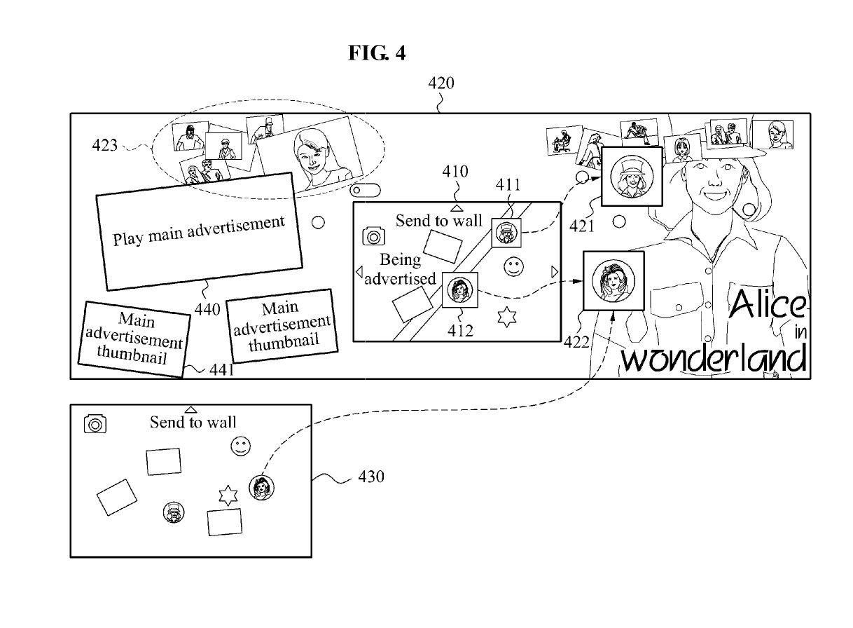

FIG. 4 is a diagram illustrating an example in which a film advertisement is displayed using a system for displaying a multimedia advertisement using a touch screen 410 and a projector according to an embodiment of the present invention.

Referring to FIG. 4, an image associated with a film to be advertised on a wall screen 420 may be displayed on a background. A main advertisement of a corresponding film may be played in a left side area 440 of the wall screen 420. In particular, an advertisement may be played on the wall screen 420 irrespective of an operation of a user through the touch screen 410. A thumbnail 441 with respect to the main advertisement disposed below the left side area 440 may be displayed. The main advertisement of the corresponding film may be a preview of the corresponding film. Aside from a film advertisement, a type of an advertisement may include various types.

Film icons 411 and 412 may be displayed on the touch screen 410. The film icons 411 and 412 may be characters appearing in a film displayed on the wall screen 420. Both an advertising icon and a fun icon may be displayed on the touch screen 410.

The user may move the film icon 411 into contact with a boundary of the touch screen 410 by flicking. A control module may control a projector to play a film advertising video 421 corresponding to the film icon 411 on the wall screen 420 when the film icon 411 arrives at an area of the wall screen 420. The film advertising video 421 may be a portion of main scenes of the corresponding film. The film advertising video 421 may be a video related to a character corresponding to the film icon 411. The film icon 411 may be re-displayed on the touch screen 410 when a playback of the film advertising video 421 is completed.

When the user moves the film icon 412 toward the wall screen 420, a film advertising video 422 corresponding to the film icon 412 may be played on the wall screen 420. In this instance, the film icon 412 may differ from the film icon 411, correspondingly the film advertising video 422 may be different from the film advertising video 421.

A second touch screen 430 may perform the same function as the touch screen 410.

When a user inputs a touch event with respect to the film icons 411 and 412 directly, the film advertising videos 421 and 422 may be played to increase a level of interest of the user on the film advertising videos 421 and 422.

The user may be further enticed to view another film advertising video 422 corresponding to the film icon 412 subsequent to a film advertising video 421 corresponding to the film icon 411, by displaying the different film icons 411 and 412 corresponding to the film advertising videos 421 and 422 on the touch screen 410. Accordingly, the user may be encouraged to play film advertising videos corresponding to other film icons, thus achieving a higher level of interest than a film advertising video associated with a film to be advertised being played consecutively, and enhancing an overall advertising effect.

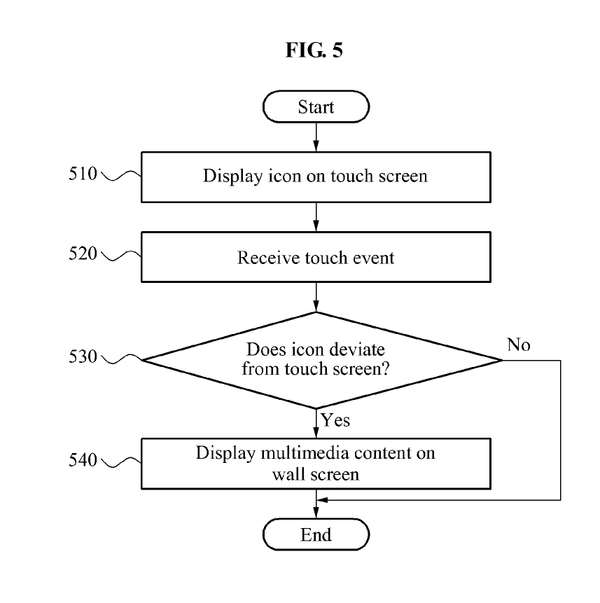

FIG. 5 is a flowchart illustrating a method for displaying a multimedia advertisement using a touch screen and a projector according to an embodiment of the present invention.

Referring to FIG. 5, in operation 510, the method for displaying the multimedia advertisement displays at least one icon including an advertising icon on a touch screen.

In operation 520, the method for displaying the multimedia advertisement may receive an input of a touch event of the user with respect to a first icon selected by a user from among the at least one icon displayed on the touch screen.

In operation 530, the method for displaying the multimedia advertisement may determine whether the first icon deviates from a boundary of the touch screen in response to the touch event of the user.

In operation 540, when the first icon deviates from the boundary of the touch screen, multimedia content corresponding to the first icon may be displayed on the wall screen using at least one projector.

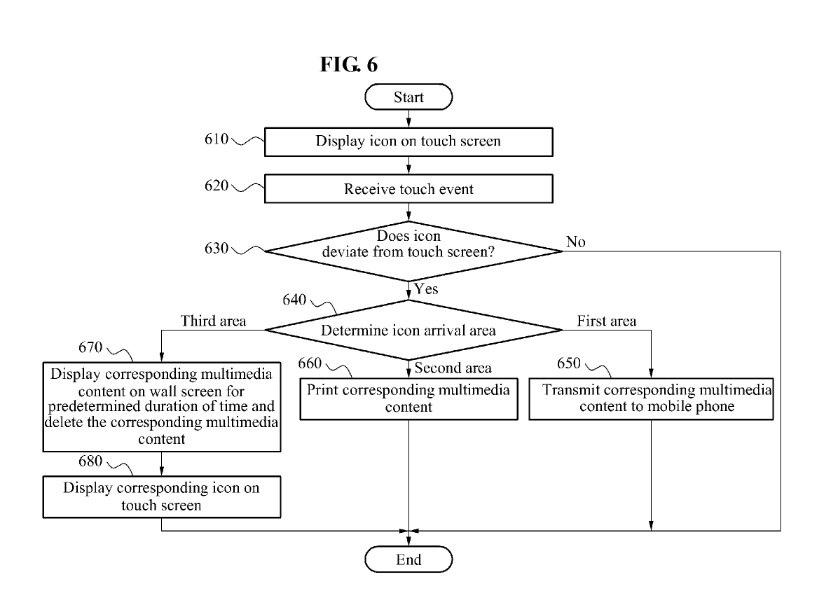

FIG. 6 is a flowchart illustrating a method for displaying a multimedia advertisement using a touch screen and a projector according to another embodiment of the present invention.

Referring to FIG. 6, the method for displaying the multimedia advertisement is applied to a case in which multimedia content corresponding to an icon displayed on a touch screen may be printed or transmitted to a mobile phone.

In operation 610, the method for displaying the multimedia advertisement may display at least one icon including an advertising icon on the touch screen.

In operation 620, the method for displaying the multimedia advertisement may receive an input of a touch event of a user with respect to a first icon selected by the user from among the at least one icon displayed on the touch screen.

In operation 630, the method for displaying the multimedia advertisement may determine whether the first icon deviates from a boundary of the touch screen by the touch event of the user.

In operation 640, when the first icon deviates from the boundary of the touch screen, the method for displaying the multimedia advertisement may determine an arrival area of the first icon.

In operation 650, when the first icon arrives at a first area, the method for displaying the multimedia advertisement may transmit multimedia content corresponding to the first icon to a mobile phone of the user. As an example, the first area may refer to a mobile phone transmission menu area.

In operation 660, when the first icon arrives at a second area, the method for displaying the multimedia advertisement may print the multimedia content corresponding to the first icon. As an example, the second area may refer to a printer menu area.

In operation 670, when the first icon arrives at the second area, the method for displaying the multimedia advertisement may display the multimedia content corresponding to the first icon on the wall screen, and delete the first icon from the wall screen subsequent to a predetermined duration of time elapsing. In operation 680, the method for displaying the multimedia advertisement may re-display the deleted first icon on the touch screen. As an example, a third area may refer to a remaining area aside from the first area and the second are in the wall screen.

A method for displaying a multimedia advertisement using a touch screen and a projector is described in the foregoing. Since the same descriptions of various embodiments relating to FIGS. 1 to 4 may be applied to the method for displaying the multimedia advertisement using the touch screen and the projector, further descriptions will not be provided in detail for ease of description and conciseness.

Hereinafter, other embodiments of the present invention will be described. The same descriptions in the foregoing may be applied to the following embodiments, and thus, a repeated description will be omitted.

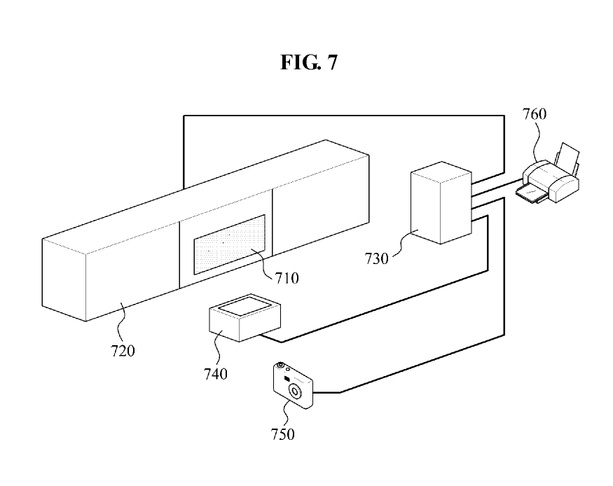

FIG. 7 is a diagram illustrating a system for displaying a multimedia advertisement using a touch screen according to an embodiment of the present invention.

Referring to FIG. 7, the system for displaying the multimedia advertisement using the touch screen includes a touch screen 710, a display device 720, and a control module 730, and further includes a second touch screen 740, a camera 750, and a printer 760.

The touch screen 710 may display at least one icon including an advertising icon. The at least one icon may include at least one of a fun icon, a photographing icon, a picture icon, and a video icon. Accordingly, a user may watch multimedia content spontaneously through an input of a touch event with respect to various icons. Due to a natural exposure to an advertisement in such a process, an aversion or reluctance to the advertisement may be avoided and the user may watch the advertisement comfortably.

The touch screen 710 may receive the input of the touch event with respect to the first icon selected by the user from among the at least one icon. As an example, the touch screen 710 may be a multi touch screen.

The display device 720 may be distinguished from the touch screen 710, and display multimedia content corresponding to the first icon in response to the touch event of the user. The display device 720 may refer to various display devices such as a liquid crystal display (LCD), a plasma display panel (PDP), a light emitting diode (LED), and the like. The display device 720 may be disposed in a position to surround the touch screen 710. In particular, the touch screen 710 and the display device 720 may be disposed in an arrangement in which a boundary of the touch screen 710 and a boundary of the display device 720 are connected. Accordingly, a video displayed on the touch screen 710 and a video displayed on the display device 720 may be connected.

The control module 730 may control an operation of the touch screen 710 and the display device 720. The control module 730 may control an operation of the second touch screen 740, the camera 750, and the printer 760. More particularly, the control module 730 may determine whether the multimedia content corresponding to the first icon is to be displayed on the display device 720 in response to the touch event of the user. For example, the control module 730 may determine whether the multimedia content corresponding to the first icon is to be displayed on the display device 720 based on whether the first icon deviates from the boundary of the touch screen by the touch event.

The touch event may be input through the second touch screen 740 aside from the touch screen 710. The second touch screen 740 may be installed on a position separate from the display device 720. The second touch screen 740 may perform the same function as the touch screen 710, and may be installed along with the touch screen 710 simultaneously.

The camera 750 may perform photographing of a picture or recording of a video based on a touch event with respect to the photographing icon displayed on the touch screen 710. The camera 750 may be embedded on a top of the second touch screen 740, or installed adjacent to the second touch screen 740.

The control module 730 may generate a picture icon or a video icon based on the photographed picture or the recorded video by the camera 750. The picture icon or the video icon may be generated by combining the photographed picture or the recorded video with an image associated with an advertising icon displayed on touch screen 710 or the second touch screen 740. The control module 730 may control the touch screen 710 or the second touch screen 740 for the picture icon or the video icon to be displayed.

The printer 760 may print the multimedia content corresponding to the first icon based on the touch event according to a control by the control module 730. In particular, advertising content or a coupon corresponding to the advertising icon, a picture corresponding to the picture icon, and the like, may be printed. In a case of the picture, the advertising content may be inserted as a background of the picture, as described in the preceding. The printer 760 may be disposed to be connected to the display device 720, or output a print from a portion on which a printer menu is displayed in the display device 720, while being embedded on a back of the display device 720.

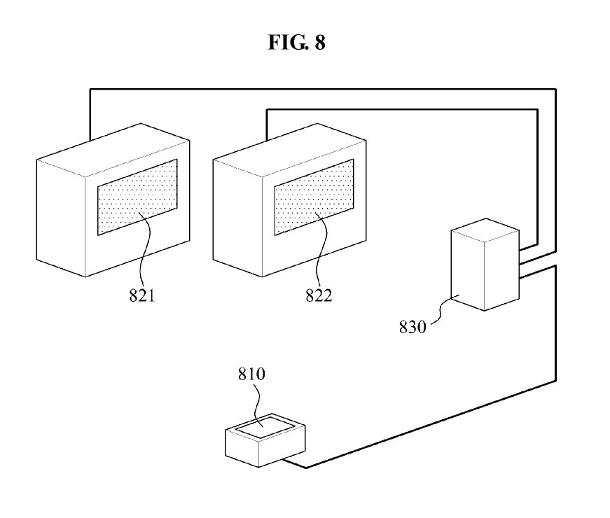

FIG. 8 is a diagram illustrating a system for displaying a multimedia advertisement using a touch screen according to another embodiment of the present invention.

Referring to FIG. 8, the system for displaying the multimedia advertisement includes a plurality of display devices 821 and 822 that display multimedia content based on a touch event input through a touch screen 810.

The plurality of display devices 821 and 822 may display an identical video or a different video. For example, when a user moves a first icon selected by the user toward the display device 821 using the touch event on the touch screen 810, multimedia content corresponding to the first icon may be displayed on the display device 821. When the first icon is moved toward the display device 822, corresponding multimedia content may be displayed on the display device 822.

A control module 830 may control the plurality of display devices 821 and 822 for multimedia content to be displayed by analyzing a touch event.

Although the two display devices 821 and 822 are illustrated in FIG. 8, it should be understood that an embodiment in which more than three display devices exist may be applied.

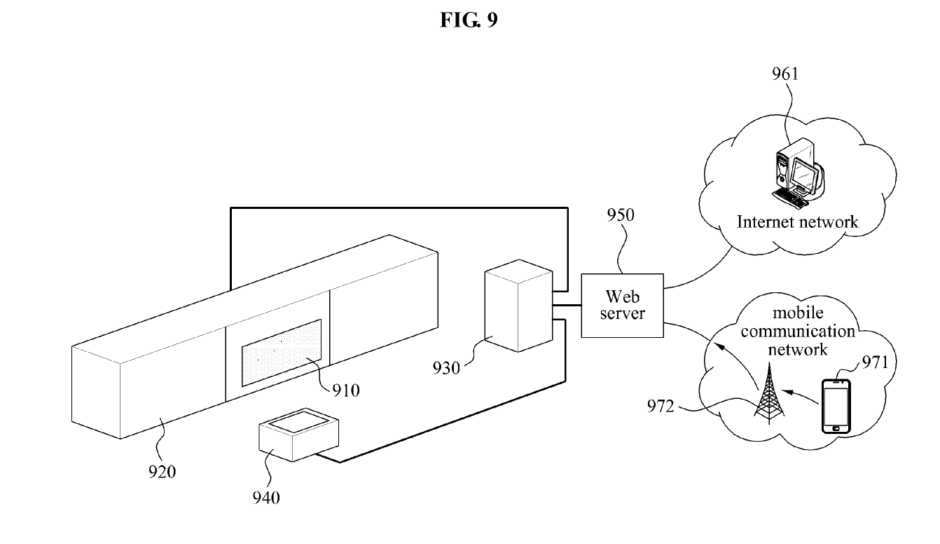

FIG. 9 is a diagram illustrating a system for displaying a multimedia advertisement using a touch screen that receives a picture or a video via an Internet network or a mobile communication network according to an embodiment of the present invention.

Descriptions in the foregoing may be applied to a touch screen 910, a display device 920, a control module 930, and a second touch screen 940.

A web server 950 may receive a picture or a video through an Internet network or a mobile communication network.

More particularly, when a user transmits a picture or a video through a web page using a computer 961, and the like, the picture or the video may be stored in the web server 950 via the mobile communication network.

When the user transmits a picture photographed or a video recorded using a mobile device 971 such as a mobile phone, and the like, the picture or the video may be transferred to the web server 950 via the mobile communication network through a base station 972, and the like.

The control module 930 may receive a picture or a video transmitted by the user from the web server 950. The control module 930 may generate a picture icon or a video icon corresponding to a picture or a video, and control the touch screen 910 and the second touch screen 940 for the picture icon or the video icon to be displayed.

The control module 930 may control the touch screen 910 and the second touch screen 940 for the picture icon or the video icon to be displayed at a point of time input in advance by the user.

The picture icon or the video icon may be generated based on a picture or a video transmitted from the user and an advertisement corresponding to an advertising icon displayed on the touch screen 910 and the second touch screen 940. More particularly, the picture icon or the video icon may be generated in a form in which an image associated with the advertising icon is inserted in a background of the picture or the video transmitted from the user.

Descriptions previously provided in FIG. 8 may be applied to the devices relating to FIG. 9 and thus, a repeated description will be omitted for conciseness.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for displaying a multimedia advertisement using a touch screen and a projector, the method comprising:
displaying at least one icon including an advertising icon on a touch screen;
receiving an input of a touch event with respect to a first icon selected by a user from among the at least one icon;
determining whether the first icon selected by the user deviates from a boundary of the touch screen by the touch event; and
displaying multimedia content corresponding to the first icon selected by the user on a wall screen using at least one projector based on the determination.

2. The method of claim 1, wherein the touch screen and the wall screen are disposed in an arrangement in which the boundary of the touch screen and a boundary of the wall screen are connected.

3. The method of claim 1, wherein the displaying of the multimedia content corresponding to the first icon selected by the user on the wall screen comprises:
displaying a video on the wall screen in an arrangement in which a video displayed on the boundary of the touch screen and a video displayed on the boundary of the wall screen are connected.

4. The method of claim 1, wherein the displaying of the multimedia content corresponding to the first icon selected by the user on the wall screen comprises:
displaying the multimedia content corresponding to the first icon selected by the user on the wall screen when the first icon selected by the user arrives at a predetermined area of the wall screen in response to the touch event.

5. The method of claim 1, wherein the displaying of the multimedia content corresponding to the first icon selected by the user on the wall screen comprises:
displaying the first icon selected by the user in a floating disposition on the wall screen; and
deleting the first icon selected by the user from the wall screen subsequent to a predetermined duration of time elapsing.

6. The method of claim 1, wherein the displaying of the multimedia content corresponding to the first icon selected by the user on the wall screen comprises:
printing advertising content or a coupon corresponding to the advertising icon, or transmitting the advertising content or the coupon to a mobile phone of a user when the first icon selected by the user is the advertising icon.

7. The method of claim 1, wherein the displaying of the at least one icon comprises:
displaying a photographing icon, and further comprises:
performing photographing in response to an input of a touch event with respect to the photographing icon being received; and
displaying a picture icon displaying the photographed picture on the touch screen.

8. The method of claim 7, wherein the displaying of the multimedia content corresponding to the first icon selected by the user on the wall screen comprises:
printing the photographed picture, or transmitting the photographed picture to a mobile phone of a user when the first icon selected by the user is the picture icon.

9. The method of claim 1, further comprising:
displaying at least one multimedia advertisement on the wall screen using the at least one projector, irrespective of the touch event.

10. A system for displaying a multimedia advertisement using a touch screen and a projector, the system comprising:
a touch screen to display at least one icon including an advertising icon, and receive an input of a touch event with respect to a first icon selected by a user from among the at least one icon;
at least one projector to display multimedia content corresponding to the first icon selected by the user on a wall screen when the first icon selected by the user deviates from a boundary of the touch screen; and
a control module to control an operation of the touch screen and the at least one projector.

11. The system of claim 10, wherein the touch screen is disposed in an arrangement in which the boundary of the touch screen and a boundary of the wall screen are connected.

12. The system of claim 10, wherein the at least one projector displays a video on the wall screen in an arrangement in which a video displayed on the boundary of the touch screen and a video displayed on the wall screen are connected.

13. The system of claim 10, wherein the control module determines whether the first icon selected by the user arrives at a predetermined area of the wall screen in response to the touch event, and when the first icon selected by the user is determined to arrive at the predetermined area of the wall screen, controls the at least one projector to display the multimedia content corresponding to the first icon selected by the user on the wall screen.

14. The system of claim 10, wherein the control module displays the first icon selected by the user in a floating disposition on the wall screen when the first icon deviates from the boundary of the touch screen, and subsequent to a predetermined duration of time elapsing, controls the at least one projector to delete the first icon selected by the user from the wall screen.

15. The system of claim 10, further comprising:
a printer to print advertising content or a coupon corresponding to the advertising icon or a picture corresponding to a picture icon when the first icon selected by the user is the advertising icon or the picture icon,
wherein the control module transmits the advertising content or the coupon corresponding to the advertising icon or the picture corresponding to the picture icon to a mobile phone of a user when the first icon selected by the user is the advertising icon or the picture icon.

16. A system for displaying a multimedia advertisement using a touch screen, the system comprising:
a touch screen to display at least one icon including an advertising icon, and receive an input of a touch event with respect to a first icon selected by a user from among the at least one icon;
a display device distinguished from the touch screen to display multimedia content corresponding to the first icon selected by the user, in response to the touch event; and
a control module to control an operation of the touch screen and the display device,
wherein the control module determines whether the multimedia content corresponding to the first icon selected by the user is to be displayed on the display device in response to the touch event.

17. The system of claim 16, wherein the control module determines whether the multimedia content corresponding to the first icon selected by the user is to be displayed on the display device based on whether the first icon selected by the user deviates from a boundary of the touch screen by the touch event.

18. The system of claim 16, wherein the at least one icon comprises at least one of:
a fun icon, a photographing icon, a picture icon, and a video icon.

19. The system of claim 16, wherein the control module receives a picture or a video via an Internet network or via a mobile communication network from a mobile device, and
the touch screen displays a picture icon or a video icon corresponding to the picture or the video.

20. The system of claim 16, further comprising:
a camera to perform photographing in response to a touch event with respect to a photographing icon displayed on the touch screen,
wherein the touch screen displays a picture icon based on the photographed picture.

21. The system of claim 19, wherein the control module creates the picture icon based on the advertising icon and the photographed picture.

22. The system of claim 19, further comprising:
a printer to print advertising content or a coupon corresponding to the advertising icon or a picture corresponding to the picture icon, based on the touch event according to a control by the control module.
